(19) United States
(12) Patent Application Publication
(10) Pub. No.: US 2013/0182668 A1
(43) Pub. Date: Jul. 18, 2013

(54) METHOD FOR PROCESSING CARRIER STATE IN CARRIER AGGREGATION SYSTEM, AND USER EQUIPMENT

(71) Applicant: FUJITSU LIMITED, Kawasaki-shi (JP)

(72) Inventors: Haibo XU, Beijing (CN); Yanling LU, Beijing (CN); Yoshiaki OHTA, Kawasaki (JP); Hua ZHOU, Beijing (CN)

(73) Assignee: FUJITSU LIMITED, Kawasaki-shi (JP)

(21) Appl. No.: 13/788,371

(22) Filed: Mar. 7, 2013

Related U.S. Application Data
(63) Continuation of application No. PCT/CN2010/077363, filed on Sep. 27, 2010.

(51) Int. Cl. H04W 74/08

(52) U.S. Cl. CPC H04W 74/0833
USPC 370/329

(57) ABSTRACT

A method for processing carrier state in a carrier aggregation system and a User Equipment (UE) are provided, so as to avoid the random access failure caused by current deactivation mode of the Secondary Component Carrier (SCC). In one embodiment of the present invention, the method includes: performing a random access on a SCCs pair; stopping or ignoring a deactivation timer of a downlink SCC of the SCCs pair before the random access succeeds.

### CROSS-REFERENCE TO RELATED APPLICATIONS

This application is a continuation of International Patent Application No. PCT/CN2010/077363 filed on Sep. 27, 2010, now pending, the contents of which are herein wholly incorporated by reference.

### FIELD OF THE INVENTION

The present invention relates to a wireless communication technology, and particularly, to a method for processing carrier state in a carrier aggregation system, and a user equipment.

### DESCRIPTION OF THE RELATED ART

With the freezing of the Long Term Evolution (LTE) project of the Universal Mobile Telecommunications System (UMTS) started by the 3GPP, the 3GPP organization has begun to study the fourth generation (4G) mobile communication system, such as the LTE-Advanced (LTE-A). In order to meet the requirement of high data rate (1 Gbps downlink and 500 Mbps uplink) made by the International Telecommunication Union (ITU) with respect to the 4G system, the 3GPP proposes the carrier aggregation technology in the LTE-A to support a bandwidth satisfying the requirement of high data rate. The carrier aggregation technology can aggregate multiple carriers of different bands into a bandwidth up to 100M, so that the User Equipment (UE) (also called as mobile terminal, mobile station, etc.) of the LTE-A can receive and/or transmit data on multiple carriers, thus the bandwidth for transmitting or receiving data exceeds 20M.

In the carrier aggregation technology, each aggregated carrier is called as a Component Carrier (CC). The base station (Evolved NodeB, called eNB for short) can configure a plurality of CCs for the UE according to the traffic requirement of the UE. One CC of the configured CCs is defined as the Primary CC (PCC), and other CCs are defined as the Secondary CCs (SCCs). In consideration of the dynamic change of the traffic amount of the UE, the activation/deactivation operation is introduced for the downlink SCCs, so as to better save the UE power. That is to say, according to the downlink traffic amount of the UE, the eNB may control the UE to perform an activation/deactivation operation on the downlink SCC. The UE does not need to perform the following operations after deactivating one downlink SCC: 1) listening the Physical Downlink Control Channel (PDCCH) of the CC; 2) listening the Physical Downlink Share Channel (PDSCH) of the CC; and 3) feeding back the Channel Quality Information (CQI) of the CC. And the UE needs to perform the above operations 1) to 3) after activating one downlink SCC. The present protocol defines two activation/deactivation modes for downlink SCC:

Mode 1: the eNB controls the UE to activate/deactivate each downlink SCC through a Medium Access Control (MAC) signaling.

Mode 2: the UE establishes a deactivation timer for each SCC. Under the following three conditions, the UE will start (or restart) respective deactivation timer of the downlink SCC:

1) the UE receives an MAC signaling that requires to activate the downlink SCC;

2) the UE receives, on the downlink SCC, a PDCCH signaling that indicates to schedule the SCC to transmit uplink data on the Physical Uplink Share Channel (PUSCH) or to receive downlink data on the PDSCH;

3) the UE receives, on other CC, a PDCCH signaling that indicates to schedule the downlink SCC to receive downlink data on its PDSCH.

During the timing period of corresponding deactivation timer, the UE always keeps the downlink SCC in an activated state. When the corresponding deactivation timer expires, the UE deactivates the SCC.

In addition, currently in the industry, another mode for downlink SCC deactivation is under discussion: when the Time Advance Timer (TAT) expires, the UE deactivates all its downlink SCCs in the activated state.

In order to keep an uplink synchronization of the UE, the eNB sends a Time Advance Command (TAC) to the UE at a regular time interval. The UE will maintain a TAT used in the process of the uplink synchronization. Once a TAC is received, the UE restarts the TAT. If the UE still does not receive the TAC after the TAT expires, it means that the UE has missed the uplink synchronization. Before an uplink or downlink data communication, the UE shall firstly perform a random access process to obtain the uplink synchronization.

In the current Rel-10, although a plurality of CCs are configured, all the configured CCs may employ just one uplink synchronization process, i.e., the establishment and the maintenance of the uplink synchronization only need to be made on the PCC. Once the PCC is in the uplink synchronized state, the uplink synchronization of all the SCCs can be ensured. Thus in the current Rel-10, the random access process for establishing the lo uplink synchronization is only performed on the PCC, rather than any SCC. But in the subsequent version, different uplink CCs may require individual uplink synchronization processes, thus the random access process shall also be performed on the SCCs.

The random access is a principal step for the UE to establish a connection and perform a communication with the eNB in the mobile communication system. The purpose of the random access is to make the UE establish a connection with the network or obtain an uplink synchronization. In the LTE system, the random access process may be classified into a contention-based random access and a non-contention-based random access. The non-contention-based random access is usually used in three scenes, i.e., downlink data being arriving while the UE does not obtain the uplink synchronization, switching and positioning. In that case, the eNB may designate to the UE the preamble resource for the random access through a PDCCH order or a switching order, thereby avoiding a confliction between the UE and other UE caused by selecting the same resource. The contention-based random access is applicable to any process that requires initiating a random access. In addition to the above three scenes, others include an RRC initial connection establishment, an RRC connection reestablishment, and uplink data being arriving while the UE does not obtain the uplink synchronization. The random access process may be triggered by the eNB (e.g., through a PDCCH order) or the UE itself (e.g., through an MAC sublayer). FIG. 1 is a flowchart of a contention-based random access initiated by a UE in the prior art. As illustrated in FIG. 1, the process includes:

Step S101: transmitting a preamble. The preamble is identified by a unique identifier RAPID. The UE may transmit the selected preamble on the selected time-frequency resource.

If the random access is initiated by the eNB, before this step the method further includes a step of triggering by the eNB (not illustrated), e.g., the eNB sends a message such as a PDCCH order for triggering a random access to the UE.

Step S102: receiving a Random Access Response (RAR) from the eNB. The RAR is a multicast message, which can be received by any UE that selects the same time-frequency resource to transmit the preamble. Thus, after receiving the RAR, the UE will lo detect whether the RAR contains a matched RAPID, and if so, the UE deems that the RAR is successfully received. If no RAR is received, or the received RAR does not contain the RAPID, the UE deems that the random access fails.

Step S103: transmitting to the eNB uplink data (i.e., Msg3) that may include a Cell Radio Network Temporary Identifier (C-RNTI) of the UE and other information.

Step S104: the UE receives a contention resolution message (i.e., Msg4) from the eNB, and the random access succeeds.

For the non-contention-based random access, after transmitting the preamble to the eNB and receiving the random access response from the eNB, the UE may further listen a PDCCH signaling coming from the eNB and indicating an uplink grant or a downlink allocation.

As can be seen from the above, the prior art does not concern the random access on the SCC, and no one pays attention to or solves the problem of the random access on the SCC caused by the deactivation mode of the present downlink SCC.

### SUMMARY OF THE INVENTION

The present invention is directed to provide a method for processing carrier state in a carrier aggregation system and a user equipment, so as to overcome one or more deficiencies existed due to the limitations of the prior art, and provide at least one beneficial selection.

A first aspect according to of the present invention provides a method for processing carrier state in a carrier aggregation system, comprising: performing a random access on a SCCs pair; and stopping or ignoring a deactivation timer of a downlink SCC of the SCCs pair before the random access succeeds.

A second aspect according to of the present invention further provides a method for processing carrier state in a carrier aggregation system, comprising: if a TAT corresponding to a SCCs pair expires, deactivating a downlink SCC of the SCCs pair, and stopping or ignoring a deactivation timer of the downlink SCC.

A third aspect according to of the present invention further provides a UE, comprising: a transmitting unit for transmitting a preamble to a base station on an uplink SCC of a SCCs pair, so as to request a random access to the base station; a receiving unit for receiving a response from the base station on a downlink SCC of the SCCs pair; and a timing control unit for stopping or ignoring a deactivation timer of the downlink SCC before the random access succeeds.

A fourth aspect according to of the present invention further provides a UE, comprising: a TAT corresponding to a SCCs pair; an activation control unit for deactivating a downlink SCC of the SCCs pair when the TAT expires; and a timing control unit for stopping or ignoring a deactivation timer of the downlink SCC when the TAT expires.

The first aspect according to of the present invention avoids the problem that a random access cannot be performed normally due to the expiring of the deactivation timer of the downlink SCC when the random access is performed on the SCC.

The second aspect according to of the present invention avoids the problem that a random access cannot be performed normally due to the existing mode in which the CC is deactivated when the TAT expires.

The third aspect according to of the present invention avoids the problem that a random access cannot be performed normally due to the expiring of the deactivation timer of the downlink SCC when the random access is performed on the SCC.

The fourth aspect according to of the present invention avoids the problem that a random access cannot be performed normally due to the existing mode in which the CC is deactivated when the TAT expires.

In order to achieve the aforementioned and relevant objects, the present invention includes the features sufficiently described later and specifically pointed out in the claims. The following descriptions and drawings detailedly elaborate the specific exemplary embodiments of the present invention. However, these embodiments are just several ones of various embodiments capable of using the principle of the present invention. According to the following detailed descriptions of the present invention made with reference to the drawings, other objects, advantages and novel features will be clearer.

### BRIEF DESCRIPTION OF THE DRAWINGS

In the drawings, the same or corresponding reference signs are used to denote the same or corresponding components throughout the drawings, and also denote the same or corresponding components in more than one embodiment. The drawings just illustrate some embodiments of the present invention, and a person skilled in the art can obtain other drawings from these drawings without paying any creative effort. In the drawings:

FIG. 1 is a flowchart of a contention-based random access in the prior art;

FIG. 2 illustrates a scene where a random access is performed on a SCC in a current activation/deactivation mode for SCC;

FIGS. 3 and 4 illustrate a random access failure due to an expiring of a deactivation timer in the scene as illustrated in FIG. 2;

FIG. 5 illustrates a flowchart of a method for processing a SCC state according to an exemplary embodiment of the present invention;

FIGS. 6 and 7 illustrate a backoff mechanism when a random access fails according to an exemplary embodiment of the present invention;

FIG. 8 illustrates a scene where a next random access is stopped due to a random access failure according to an exemplary embodiment of the present invention;

FIG. 9 illustrates a scene where a random access is performed by re-selecting a SCC due to a random access failure according to an exemplary embodiment of the present invention;

FIG. 10 illustrates a flowchart of a method for processing a SCC state according to another exemplary embodiment of the present invention;

FIG. 11 illustrates a scene of a random access failure that may be caused by a random access which is based on a TAT deactivation mode currently under discussion and performed on a SCC;

FIG. 12 illustrates a flowchart of a method for processing a SCC state according to another exemplary embodiment of the present invention;

FIG. 13 illustrates an example of a block diagram of a UE according to an exemplary embodiment of the present invention; and

FIG. 14 illustrates an example of a block diagram of a UE according to another exemplary embodiment of the present invention.

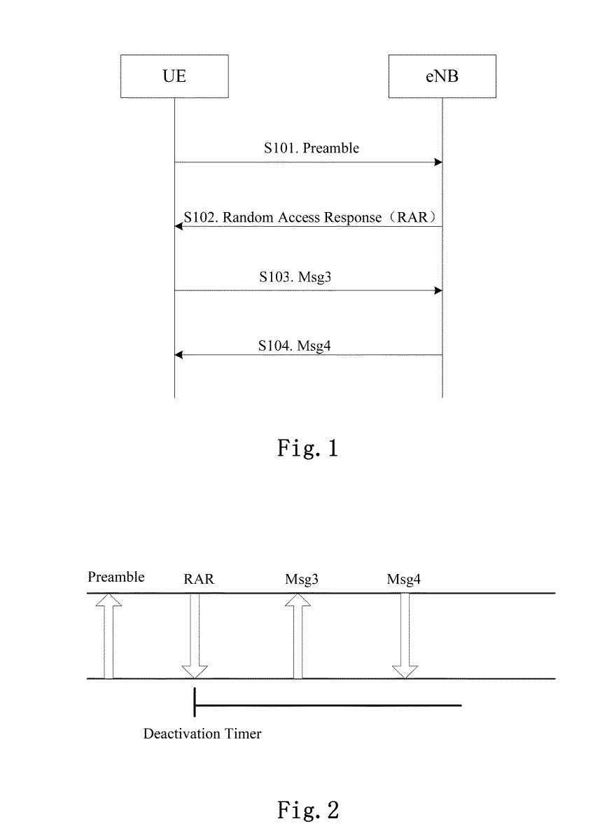

### DETAILED DESCRIPTION OF THE PREFERRED EMBODIMENTS

The technical solutions of the embodiments of the present invention will be clearly and completely described as follows with reference to the drawings. Obviously, the described embodiments are just some embodiments of the present invention rather than all the embodiments. Any other embodiment obtained by a person skilled in the art based on the embodiments of the present invention without paying any creative effort will fall within the protection scope of the present invention.

To be noted, in order to avoid the present invention being vague due to unnecessary details, the drawings only illustrate device structures and/or processing steps closely related to the solutions according to the present invention, while omitting other details not so closely related to the present invention.

The embodiments of this invention propose an effective solution for processing the state of downlink SCC in SCCs when a random access is performed on the SCCs, so as to reduce random access failures on the SCC as far as possible.

During the implementation of the present invention, the inventor finds that if the deactivation timer of the downlink SCC is employed during the random access process that uses the SCCs, then according to condition 2) in aforementioned activation/deactivation Mode 2 for SCC, the UE will start corresponding deactivation timer of the downlink SCC after receiving a random access response from the eNB, as illustrated in FIG. 2.

Assuming that the random access process is based on contention, then it may fail when preambles of a plurality of UEs collide with each other. There are three methods for the UE to detect a random access failure: 1) after the preamble is transmitted, no random access response message is received from the eNB within a time window (hereinafter referred to as random access response time window); 2) after the preamble is transmitted, a random access response message is received from the eNB within a random access response time window; but the random access response message does not contain the identifier RAPID of the preamble transmitted by the UE, i.e., it is not a random access response message for the UE; and 3) a contention resolution timer is started after Msg3 is transmitted, and no contention resolution message is received from the eNB before the contention resolution timer expires.

In the above cases of random access failure, cases 1 and 2) are failures of reception of the random access response, while case 3) is a failure of reception of the contention resolution message.

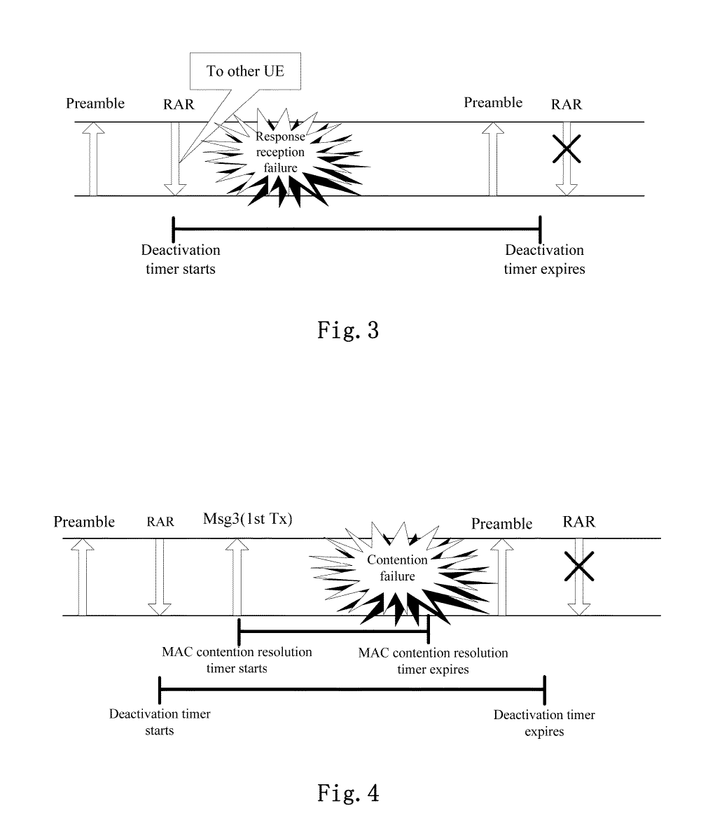

The UE will adopt the backoff mechanism after finding the random access failure, and initiate a random access process again after a certain backoff period. The parameter of the backoff period may be pre-stored in the UE, or carried in a signaling (e.g., a random access response or other message) from the eNB. In that case, if the UE starts the deactivation timer after receiving the random access response message in the previous random access process, and if the deactivation timer expires after transmitting the preamble and before receiving a random access response from the eNB in the random access process initiated again, the UE will stop listening the PDCCH, thus the random access response message cannot be received normally, and the random access process fails, as illustrated in FIGS. 3 and 4.

Therefore, during the random access process on the SCC, if the deactivation timer is started in the current activation/deactivation mode for downlink SCC, it causes a problem (hereinafter called as Problem 1) that the random access cannot be performed normally due to the expiring of the deactivation timer of the downlink SCC.

In addition, although the method for CC deactivation currently under discussion in the industry proposes that the UE deactivates all its SCCs in the activated state when the TAT expires, it does not specify whether to stop corresponding deactivation timer after the downlink SCCs are deactivated due to the expiring of the TAT.

The problem as illustrated in FIG. 11 will occur if the deactivation timer is not stopped. After initiating the random access process, the UE will stop listening the PDCCH if the deactivation timer expires after transmitting the preamble and before receiving the random access response from the eNB. As a result, the random access response message cannot be received normally, and the random access process fails.

That is to say, the TAT-based deactivation mode currently under discussion may have the problem that a random access cannot be performed normally due to the expiring of the TAT when the random access is performed on the SCC. Hereinafter the problem is called as Problem 2.

The embodiments of the present invention are proposed with respect to the above Problems 1 and 2.

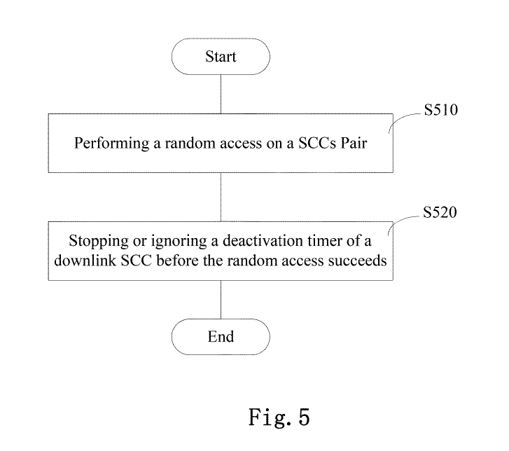

In order to solve Problem 1, i.e., to prevent a random access failure that may be caused by starting the deactivation timer during the random access process. In one embodiment of the present invention, as illustrated in FIG. 5, the method for processing CC state includes:

Step S510: performing a random access on a pair of SCCs.

The pair of SCCs (e.g., SCCs pair SCC1) includes one uplink SCC and one downlink SCC. The random access may be initiated by the eNB (e.g., the eNB sends a PDCCH order to the UE) or by the UE (e.g., MAC layer triggering). After receiving the PDCCH order from the eNB or being triggered by the MAC layer of itself, the UE transmits a preamble for the random access to the eNB on the uplink SCC, and listens a response from the eNB on the downlink SCC. When the random access is performed on the SCCs pair, the downlink SCC may be activated before or after the preamble is transmitted to the eNB, so as to listen the PDCCH and the PDSCH.

Step S520: stopping or ignoring a deactivation timer of the downlink SCC before the random access succeeds.

Herein stopping the deactivation timer of the downlink SCC means not to start the deactivation timer of the downlink SCC, and ignoring the deactivation timer of the downlink SCC means not to make any action in response to the expiring of the deactivation timer of the downlink SCC even if it is started, i.e., regarding the deactivation timer of the downlink SCC as being stopped. Thus, in the embodiment of the present invention, the deactivation timer of the downlink SCC will not be used before the random access succeeds.

For instance, in one example, when a random access is initiated, if the downlink SCC is in the deactivated state and the random access process is initiated by the UE, the downlink SCC is activated implicitly after the UE transmits the preamble, but corresponding deactivation timer is stopped rather than being started. In that case, if the deactivation timer of the downlink SCC has been started, it will be stopped or ignored (not making any respond to the expiring of the deactivation timer).

In addition, when a random access is initiated, if the downlink SCC is in the deactivated state and the random access process is initiated by the eNB, the downlink SCC is activated implicitly after the UE receives a PDCCH order from the eNB, but corresponding deactivation timer is stopped rather than being started. In that case, if the deactivation timer of the downlink SCC has been started, it will be stopped or ignored.

In addition, when a random access is initiated, if the downlink SCC is in the activated state and the random access process is initiated by the UE, the activated state is kept, and the deactivation timer is stopped or ignored after the UE transmits the preamble.

In addition, when a random access is initiated, if the downlink SCC is in the activated state and the random access process is initiated by the eNB, the activated state is kept, and corresponding deactivation timer of the downlink SCC is stopped or ignored after the UE receives the PDCCH order from the eNB.

The above cases for activating and stopping the deactivation timer are just exemplary, and the present invention is not limited thereto. For example, when a random access is performed by either the UE or the eNB, the downlink SCC may be activated after the UE transmits the preamble, and the deactivation timer is stopped or ignored.

As compared with the cases that the deactivation timer is used during the random access, this embodiment effectively avoids the random access failure caused by the expiring of the deactivation timer of the downlink SCC by not using the deactivation timer of the downlink SCC during the random access, and thus decreases the possibility of the random access failure.

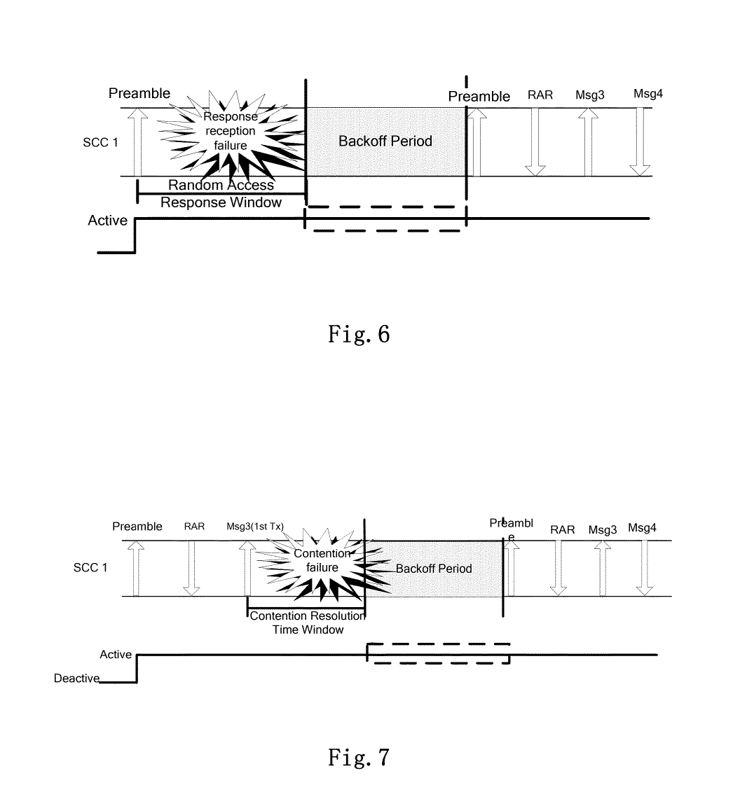

In the above embodiment, the downlink SCC is in the activated state when the random access is performed, because the UE activates the downlink SCC before or after transmitting the preamble to the eNB. In that case, since the deactivation timer is not used, the downlink SCC is still in the activated state during the backoff period caused by the failure of reception of the random access response or the contention resolution message, as illustrated in FIGS. 6 and 7. During the backoff period, it is unnecessary for the UE to listen the PDCCH or the PDSCH of the downlink SCC, and the UE also will not transmit a Channel Quality Indicator (CQI) on corresponding uplink SCC, thus extra power will be wasted if the downlink SCC is activated during this period.

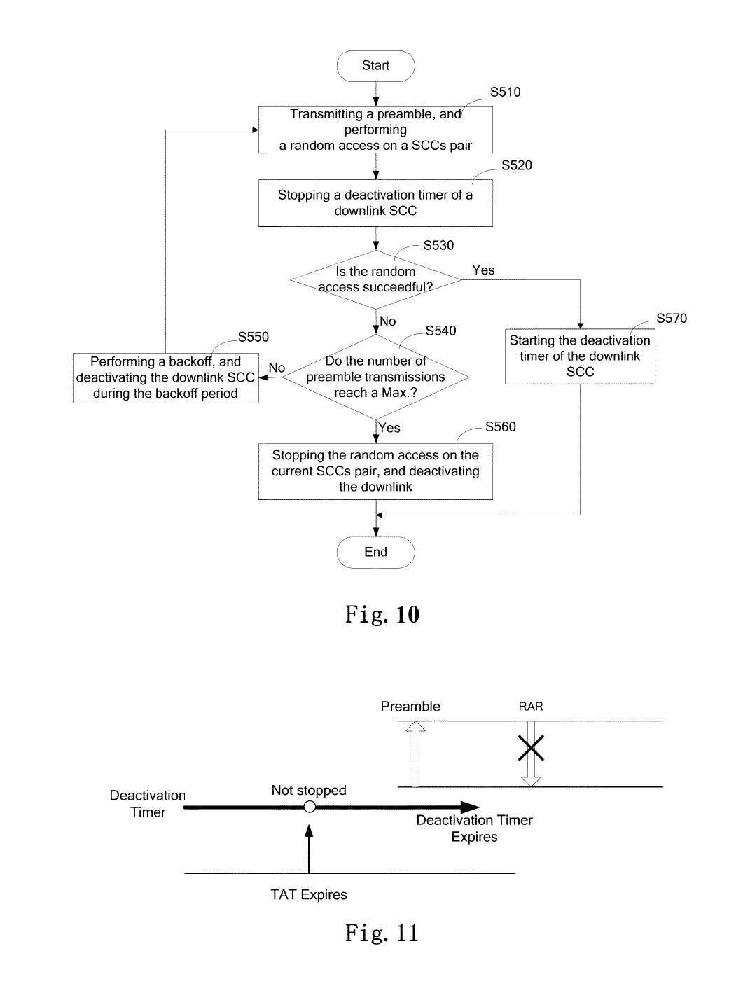

Thus, in another embodiment as illustrated in FIG. 10, a method for processing CC state includes:

Step S510: a UE transmits a preamble to an eNB, and performs a random access on a SCCs pair SCC1.

If the random access is triggered by the eNB, the UE transmits the preamble to the eNB after receiving a PDCCH order from the eNB, and listens a response from the eNB. When the random access is performed on the SCCs pair, the downlink SCC may be activated before or after the preamble is transmitted to the eNB, so as to listen the PDCCH and the PDSCH.

Step S520: stopping or ignoring a deactivation timer of a downlink SCC before the random access succeeds.

If the current random access fails (“No” in step S530), and the number of continuous random access failures does not reach a predetermined threshold (“No” in step S540), a backoff is performed, and the downlink SCC is deactivated during the backoff period (step S550). After the backoff period, the UE returns to step S510 and retransmits the preamble to the eNB, so as to perform a next random access.

For example, after the UE transmits the preamble to the eNB, it deems that the reception of the random access response fails in the case that no random access response message is received in the random access response time window, or in the case that a random access response message is received in the random access response window, but the random access response message does not contain the identifier of the preamble previously transmitted by the UE. Thus the downlink SCC is deactivated in the backoff period following the random access response time window. The deactivation may be triggered by the ending of the random access response window. The downlink SCC will not be activated until the backoff is ended and the UE retransmits the preamble. Or, after a message carrying the C-RNTI of the UE is sent to the eNB, the downlink SCC is deactivated in the backoff period following a contention resolution time window if no contention resolution message is received from the eNB in the contention resolution time window. The deactivation may be triggered by the expiring of a contention resolution timer. The downlink SCC will not be activated until the backoff is ended and the UE retransmits the preamble.

The power consumption of the UE can be saved by deactivating the downlink Component Carrier during the backoff period.

Further, in the embodiment of the present invention, as illustrated in FIG. 10, the method for processing downlink SCC state further includes:

starting the deactivation timer of the downlink SCC in step S570 if the random access succeeds (“Yes” in step S530).

Specifically, for example, in case the random access is contention-based random access process, the UE starts the deactivation timer of the downlink SCC after receiving a contention resolution message from the eNB. In case the random access is non-contention-based random access process, the UE starts the deactivation timer of the downlink SCC when receiving, on the downlink SCC, a PDCCH signaling indicating to schedule uplink grant or downlink assignment of the SCCs pair SCC1, or receiving, on other CC, a PDCCH signaling indicating to schedule downlink assignment of the downlink SCC.

As mentioned above, after the failure of reception of the random access response in the random access response time window, or the failure of reception of the contention resolution message in the contention resolution time window, the user terminal will retransmit the preamble to the eNB after a certain backoff period, so as to request a random access again. In an embodiment of the present invention, in a random access process, if the random access fails, and the number of transmissions of the preamble from the UE to the eNB exceeds a maximum number (i.e., the number of continuous random access failures reaches a predetermined threshold), the UE stops the attempt of performing a random access on the SCCs pair SCC1, and deactivates the downlink SCC. Thus, the method for processing CC further includes:

If the current random access fails (“No” in step S530), and the number of continuous random access failures reaches a predetermined threshold (“Yes” in step S540), the random access on the current SCCs pair SCC1 is stopped, and the downlink SCC is deactivated (step S560).

In step S560, stopping the random access on the current SCCs pair SCC1 for example may include: the UE stops the random access, or the UE selects another CCs pair (e.g., SCC2) and switching to the said another CCs pair SCC2 to perform anew a random access process thereon, as illustrated in FIG. 10.

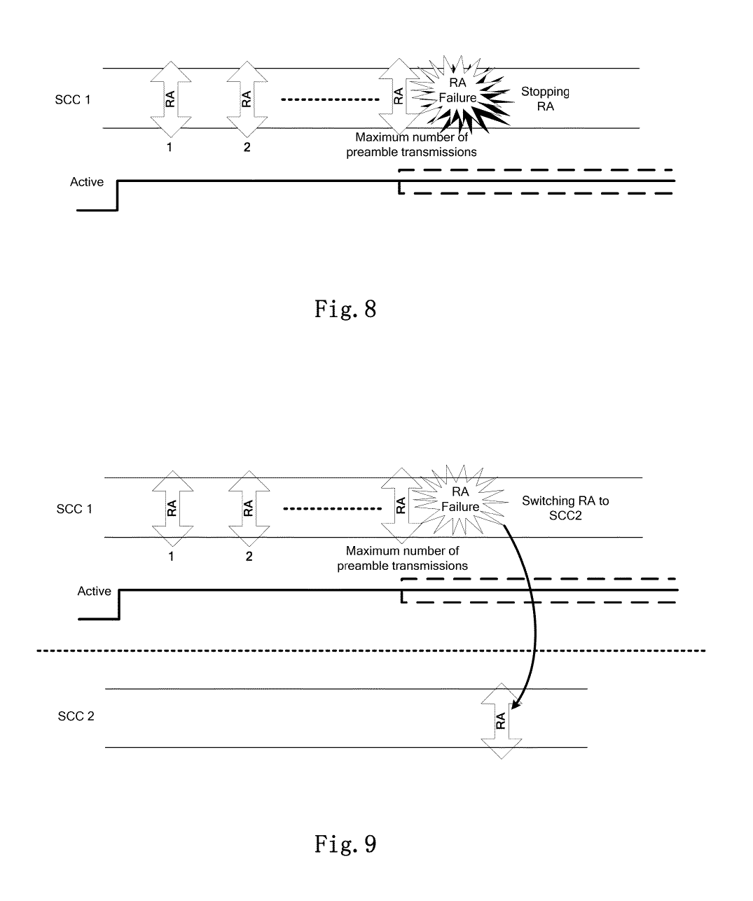

Step S560 can further save the power consumption of the UE, because as illustrated in FIG. 8, if the UE does not deactivate the downlink SCC, then the downlink SCC of the UE cannot be deactivated through an MAC signaling since the eNB cannot identify the UE, thus the downlink SCC of the UE is always in the activated state, which causes power extra waste.

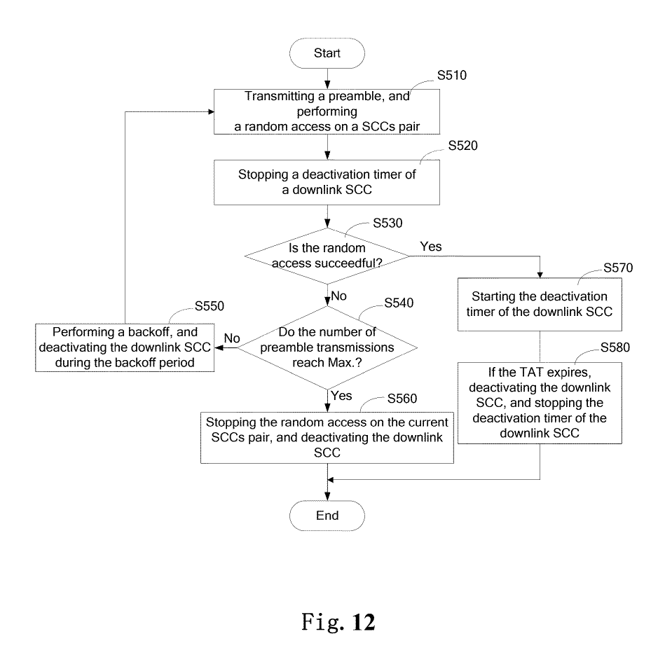

In order to solve Problem 2, i.e., to avoid a random access failure which may be caused by the mode in which the CC is deactivated by the expiring of the TAT. Another embodiment of the present invention further provides a method for processing downlink SCC state, including: each SCCs pair may be corresponding to one TAT, and if the TAT corresponding to the SCCs pair expires, deactivating a downlink SCC of the SCCs pair, and stopping or ignoring a deactivation timer of the downlink SCC. The method effectively avoids the problem that the random access process cannot be performed normally caused by not stopping the deactivation timer when the TAT expires The method of the embodiment may be performed individually, or be performed before/after any step in FIG. 10, e.g., step S580 in FIG. 12.

To be noted, the steps of the method of the present invention are not limited to the time sequence as described herein, and they may be performed orderly, concurrently or individually in other time sequence. For example, steps S510 and S520 may be performed concurrently and they are not limited to the illustrated sequence. Therefore, the technical scope of the present invention is not limited to the execution sequence of the method described herein.

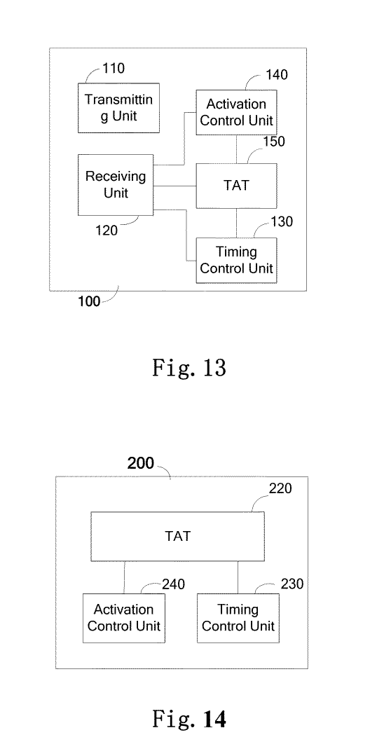

FIG. 13 illustrates a structural block diagram of a UE 100 in a embodiment of the present invention. In addition to the conventional structure (not illustrated), the UE 100 further includes a transmitting unit 110, a receiving unit 120, a first timing control unit 130 and a first activation control unit 140.

The transmitting unit 110 is configured to transmit a preamble to an eNB on an uplink SCC of a SCCs pair, so as to request a random access to the eNB.

The receiving unit 120 is configured to receive a response from the eNB on a downlink SCC of the SCCs pair.

The first timing control unit 130 is configured to stop or ignore a deactivation timer of the downlink SCC before the random access succeeds.

The first activation control unit 140 is configured to activate the downlink SCC before or after the preamble is transmitted to the eNB by the transmitting unit 110.

Preferably, the first timing control unit 130 may be further configured to start the deactivation timer after the random access succeeds.

Preferably, the first activation control unit 140 may be further configured to deactivate the downlink SCC in a backoff period before a next random access is performed, if the current random access fails and the number of continuous random access failures does not reach a predetermined threshold.

Preferably, the transmitting unit 110 may be further configured to stop transmitting the preamble to the eNB on the current uplink SCC, if the current random access fails and the number of continuous random access failures reaches a predetermined threshold. The first activation control unit 140 may be further configured to deactivate the downlink SCC after the current random access fails. In that case, the transmitting unit 110 may be further configured to transmit the preamble to the eNB on the uplink SCC of the reselected SCCs pair. The receiving unit 120 may be further configured to receive a response from the eNB on the downlink SCC of the reselected SCCs pair.

Preferably, the UE 100 may further include a TAT (not illustrated) corresponding to the SCCs pair.

The first activation control unit 140 may be further configured to deactivate the downlink SCC after the TAT expires. The first timing control unit 130 may be further configured to stop or ignore the deactivation timer of the downlink SCC after the TAT expires.

As illustrated in FIG. 14, another embodiment of the present invention provides a UE 200, including a TAT (not illustrated) corresponding to a SCCs pair. The SCCs pair is a pair of SCCs consisting of an uplink SCC and a downlink SCC.

In addition, the UE further includes a second timing control unit 230 and a second activation control unit 240. The second activation control unit 240 is configured to deactivate the downlink SCC after the TAT expires. The second timing control unit 230 is configured to stop or ignore the deactivation timer of the SCC after the TAT expires.

It shall be appreciated that each of the above parts may be implemented by hardware, software, firmware, or combinations thereof. In addition, the above parts may be combined into a larger part or divided into a plurality of smaller parts.

The above apparatuses and methods of the present invention may be implemented by hardware, or a combination of hardware and software. The present invention further relates to a computer readable program which when being executed by a logic part, enables the logic part to implement the aforementioned apparatus or constituent parts, or enables the logic part to implement the aforementioned methods or steps. The present invention further relates to a storage medium for storing the above program, such as hard disc, magnetic disc, optical disc, DVD, flash memory, etc.

Although the specific features of the present invention are described with respect to one or more exemplary embodiments, these features can be combined with one or more other features in other embodiments upon demand and in consideration of benefiting any given or specific application.

Finally to be noted, the terms the terms “comprise”, “include” or any other variant intend to cover nonexclusive inclusions, so that a process, a method, an article or a device comprising a series of elements includes not only those elements, but also other elements not explicitly listed, or inherent elements of the process, the method, the article or the device.

Although the embodiments of the present invention are detailedly described with reference to the drawings, it shall be appreciated that the above embodiments are just used to explain the present invention rather than limiting the present invention. A person skilled in the art may make various modifications and changes to those embodiments without deviating from the spirit and the scope of the present invention. Therefore, the lo scope of the present invention is only defined by the accompanied claims and their equivalents.

What is claimed is:

1. A method for processing carrier state in a carrier aggregation system, comprising:
performing a random access on a Secondary Component Carriers (SCCs) pair; and
stopping or ignoring a deactivation timer of a downlink SCC of the SCCs pair before the random access succeeds.

2. The method according to claim 1, further comprising:
activating the downlink SCC before or after transmitting a preamble to a base station.

3. The method according to claim 1, further comprising:
starting the deactivation timer after the random access succeeds.

4. The method according to claim 2, further comprising:
if the random access fails and the number of continuous random access failures does not reach a predetermined threshold, performing a next random access after a backoff period, and deactivating the downlink SCC in the backoff period.

5. The method according to claim 2, further comprising:
if the random access fails and the number of continuous random access failures reaches a predetermined threshold, stopping any random access on the SCCs pair, and deactivating the downlink SCC.

6. The method according to claim 5, further comprising:
re-selecting a Component Carriers (CCs) pair and performing a random access thereon.

7. The method according to claim 2, further comprising:
if a Time Advance Timer (TAT) corresponding to the SCCs pair expires, deactivating the downlink SCC, and stopping or ignoring the deactivation timer of the downlink SCC.

8. The method according to claim 2, wherein activating the downlink SCC before or after transmitting the preamble to the base station comprising:
after a message for triggering the random access is received from the base station, activating the downlink SCC if the downlink SCC is in a deactivated state, and keeping an activated state of the downlink SCC if the downlink SCC is in the activated state; or
after the preamble is transmitted to the base station, activating the downlink SCC if the downlink SCC is in a deactivated state, and keeping an activated state of the downlink SCC if the downlink SCC is in the activated state.

9. The method according to claim 3, wherein starting the deactivation timer after the random access succeeds comprising:
starting the deactivation timer after a contention resolution message is received from the base station; or
starting the deactivation timer when a Physical Downlink Control Channel (PDCCH) signaling indicating uplink grant or downlink assignment of the SCCs pair is received on the downlink SCC, or a PDCCH signaling indicating downlink assignment of the SCC is received on other CC.

10. The method according to claim 4, wherein the random access failure comprising:
a failure of receiving random access response in a random access response time window, after the preamble is transmitted to the base station; or
a failure of receiving contention resolution message from the base station in a contention resolution time window, after a message carrying a Cell Radio Network Temporary Identifier of a User Equipment (UE) is transmitted to the base station.

11. A method for processing carrier state in a carrier aggregation system, comprising:
if a Time Advance Timer (TAT) corresponding to a Secondary Component Carriers (SCCs) pair expires, deactivating a downlink SCC of the SCCs pair, and stopping or ignoring a deactivation timer of the downlink SCC.

12. The method according to claim 11, further comprising:
performing a random access on the SCCs pair; and
stopping or ignoring the deactivation timer of the downlink SCC before the random access succeeds.

13. The method according to claim 12, further comprising:
activating the downlink SCC before or after transmitting a preamble to a base station.

14. The method according to claim 12, further comprising:
starting the deactivation timer after the random access succeeds.

15. The method according to claim 13, further comprising:
if the random access fails and the number of continuous random access failures does not reach a predetermined threshold, performing a next random access after a backoff period, and deactivating the downlink SCC in the backoff period.

16. The method according to claim 13, further comprising:
if the random access fails and the number of continuous random access failures reaches a predetermined threshold, stopping any random access on the SCCs pair, and deactivating the downlink SCC.

17. The method according to claim 16, further comprising:
re-selecting a Component Carriers (CCs) pair and performing a random access thereon.

18. A User Equipment (UE), comprising:
a transmitting unit for transmitting a preamble to a base station on an uplink Secondary Component Carrier (SCC) of a SCCs pair, so as to request a random access to the base station;
a receiving unit for receiving a response from the base station on a downlink SCC of the SCCs pair; and
a timing control unit for stopping or ignoring a deactivation timer of the downlink SCC before the random access succeeds.

19. The UE according to claim 18, further comprising:
an activation control unit for activating the downlink SCC before or after the preamble is transmitted to the base station by the transmitting unit.

20. The UE according to claim 18, wherein the timing control unit is further configured to start the deactivation timer after the random access succeeds.

21. The UE according to claim 19, wherein the activation control unit is further configured to deactivate the downlink SCC in a backoff period before a next random access is performed, if the random access fails and the number of continuous random access failures does not reach a predetermined threshold.

22. The UE according to claim 19, wherein the transmitting unit is further configured to stop transmitting the preamble to the base station on the uplink SCC after the random access fails, if the number of continuous random access failures reaches a predetermined threshold; and
the activation control unit is further configured to deactivate the downlink SCC after the random access fails.

23. The UE according to claim 22, wherein the transmitting unit is further configured to transmit a preamble to the base station on an uplink Component Carrier (CC) of the re-selected CCs pair; and
the receiving unit is further configured to receive a response from the base station on a downlink CC of the re-selected CCs pair.

24. The UE according to claim 19, further comprising a Time Advance Timer (TAT) corresponding to the SCCs pair;
the activation control unit is further configured to deactivate the downlink SCC when the TAT expires, and
the timing control unit is further configured to stop or ignore the deactivation timer of the downlink SCC when the TAT expires.

25. A User Equipment (UE), comprising:
a Time Advance Timer (TAT) corresponding to a Secondary Component Carriers (SCCs) pair;
an activation control unit for deactivating a downlink SCC of the SCCs pair when the TAT expires; and
a timing control unit for stopping or ignoring a deactivation timer of the downlink SCC when the TAT expires.

26. The UE according to claim 25, further comprising:
a transmitting unit for transmitting a preamble to a base station on an uplink SCC of the SCCs pair, so as to request a random access to the base station; and
a receiving unit for receiving a response from the base station on the downlink SCC;
the timing control unit is further configured to stop or ignore the deactivation timer of the downlink SCC before the random access succeeds.

27. The UE according to claim 26, wherein
the activation control unit is further configured to activate the downlink SCC before or after the preamble is transmitted to the base station by the transmitting unit.

28. The UE according to claim 26, wherein
the timing control unit is further configured to start the deactivation timer after the random access succeeds.

29. The UE according to claim 27, wherein the activation control unit is further configured to deactivate the downlink SCC in a backoff period before a next random access is performed, if the random access fails and the number of continuous random access failures does not reach a predetermined threshold.

30. The UE according to claim 27, wherein
the transmitting unit is further configured to stop transmitting the preamble to the base station on the uplink SCC after the random access fails, if the number of continuous random access failures reaches a predetermined threshold; and
the activation control unit is further configured to deactivate the downlink SCC after the random access fails.

31. The UE according to claim 30, wherein,
the transmitting unit is further configured to transmit a preamble to the base station on an uplink Component Carrier (CC) of the re-selected CCs pair; and
the receiving unit is further configured to receive a response from the base station on a downlink CC of the re-selected CCs pair.

32. A computer readable program, wherein when being executed in a carrier aggregation system, the program enables a computer to execute the method for processing carrier state of claim 1 in the carrier aggregation system.

33. A storage medium that stores a computer readable program, wherein the computer readable program enables a computer to execute the method for processing carrier state of claim 1 in a carrier aggregation system.
